(19) United States
(12) Patent Application Publication
(10) Pub. No.: US 2013/0337481 A1
(43) Pub. Date: Dec. 19, 2013

(54) ASSAY METHOD

(71) Applicants: Peter David Eckersall, Glasgow (GB); Ellidh McCulloch, Glasgow (GB); Stuart Docherty, Glasgow (GB)

(72) Inventors: Peter David Eckersall, Glasgow (GB); Ellidh McCulloch, Glasgow (GB); Stuart Docherty, Glasgow (GB)

(73) Assignee: REACTIVLAB LIMITED, Glasgow (GB)

(21) Appl. No.: 13/995,894

(22) PCT Filed: Dec. 19, 2011
(86) PCT No.: PCT/GB2011/001731

§ 371 Date: Sep. 3, 2013

(30) Foreign Application Priority Data
Dec. 20, 2010 (GB) 1021509.3

(51) Int. Cl. G01N 21/78

(52) U.S. Cl. CPC G01N 21/78
USPC 435/14; 435/28

(57) ABSTRACT

The invention provides an assay method for determining a level of haptoglobin in a sample comprising the steps of: (i) mixing haemoglobin with the sample to be assayed so as to form a haptoglobin-haemoglobin complex with haptoglobin present in the sample; (ii) contacting the product of step (i) with reagents for generating hydrogen peroxide and one or more chromogens which undergo a spectroscopically detectable change when peroxidase activity is present, in the presence of a buffer, under conditions in which hydrogen peroxide is generated from said reagents and forms a substrate for the peroxidise activity of the haptoglobin-haemoglobin complex present, and wherein the pH of the buffer is within a range which is sufficiently low that the peroxidise activity of any uncomplexed haemoglobin is substantially suppressed but sufficiently high that hydrogen peroxide generation occurs; (iii) determining the peroxidase activity of the haptoglobin-haemoglobin complex by measuring the change in an optical property of the reaction mixture; and (iv) correlating the level of peroxidise activity of the haptoglobin-haemoglobin complex with the amount of haptoglobin in the sample. A kit for use in such a method is also provided.

### FIELD OF THE INVENTION

The present invention relates to an assay and kit for determining the level of haptoglobin in a sample. In particular, the present invention relates to an assay for determining the level of haptoglobin which is readily adaptable for running in a dry format where the reagents are dried onto a surface prior to running the assay.

### BACKGROUND TO THE INVENTION

Haptoglobin is one of a group of proteins, known as acute phase proteins, whose concentration increases significantly following infection, inflammation or trauma. Measuring the concentration of haptoglobin in plasma therefore provides valuable diagnostic information as to the health status of the human or animal from which the sample is obtained and there has been much interest in the art in developing an assay for haptoglobin in plasma, serum and other biological fluids.

Assays currently in use for determining the concentration of haptoglobin in a sample are generally based on either immunoassay or on a haemoglobin binding assay which relies on the ability of haptoglobin to bind to haemoglobin.

Immunoassays utilising antibody based methods with antiserum specific for haptoglobin have been developed and are known in the art. Commonly, such assays are based on immunoturbidimetric assays with the haptoglobin concentration being determined via measurement of the formulation of an antibody-haptoglobin precipitate in solution. Enzyme-linked immunosorbent assays (ELISA) are another common embodiment of such assays. Not only do such immunoassays require a continuing supply of antiserum, however, but tests have to be validated for each separate species under investigation, rending immunoassay based methods commercially less attractive.

Assays based on the ability of haptoglobin to bind to haemoglobin are now routinely used in veterinary diagnostic laboratories. These are economically more viable as they require less expensive reagents than antibody based methods and also can be performed on all species.

In EP 1031035B1 there is described a haemoglobin binding assay system which exploits the endogenous activity of haptoglobin to bind the haemoglobin. At low pH, the resulting haptoglobin-haemoglobin complex retains peroxidase activity whereas the peroxidase activity of non-bound haemoglobin is inactivated. By detecting peroxidase activity, the amount of complexed haemoglobin present, and hence the haptoglobin content of the sample, can be determined. In the assay system described in EP1031035B1, reagents such as protein binding inhibitors and reducing agents effective against disulphide bonds and/or chaotropic agents are employed to suppress the peroxidase activity of serum albumin which interferes with the assay at low blood concentrations of haptoglobin.

A major disadvantage associated with the haemoglobin binding assays described to date, such as the assay described in EP 1031035B1 discussed above, is hydrogen peroxide is required as the substrate for the peroxidase activity of the haptoglobin-haemoglobin complex. Hydrogen peroxide is highly reactive and requires stabilisation in order to prevent it oxidising the other components in the assay. This not only limits the practicality of the assay but also renders the assay unsuitable for adaption to a dry chemistry format such as a ‘dip-stick’ arrangement for visual or instrument based assessment.

U.S. Pat. No. 4,695,552 describes a method for determining the haemoglobin-haptoglobin complex in the presence of free haemoglobin which involves determining peroxidase activity. However, the substrate for the peroxidase activity is hydrogen peroxide. Hydrogen peroxide is also used as a reagent together with 3,3′,5,5′-tetramethyl benzidine in the haptoglobin determining method described in JP 2208568.

There therefore remains a continuing need for an improved assay for determining the level of haptoglobin in a sample which overcomes the problems associated with prior art assay methods.

### SUMMARY OF THE INVENTION

The present invention provides an assay method for determining a level of haptoglobin in a sample comprising the steps of:
(i) mixing haemoglobin with the sample to be assayed so as to form a haptoglobin-haemoglobin complex with haptoglobin present in the sample;
(ii) contacting the product of step (i) with reagents for generating hydrogen peroxide and one or more chromogens which undergo an optically detectable change when peroxidase activity is present, in the presence of a buffer,
under conditions in which hydrogen peroxide is generated from said reagents and forms a substrate for the peroxidise activity of the haptoglobin-haemoglobin complex present, and wherein the pH of the buffer is within a range which is sufficiently low that the peroxidise activity of any uncomplexed haemoglobin is substantially suppressed but sufficiently high that hydrogen peroxide generation occurs;
(iii) determining the peroxidase activity of the haptoglobin-haemoglobin complex by measuring the change in an optical property of the reaction mixture; and
(iv) correlating the level of peroxidise activity of the haptoglobin-haemoglobin complex with the amount of haptoglobin in the sample.

Suitably, in the above method, steps (i) and (ii) are carried out concurrently, for example by forming a reaction mixture containing all of the sample to be assayed, haemoglobin, reagents for generating hydrogen peroxide, one or more chromogens which undergoes a spectroscopically detectable change when peroxidase activity is present, and a suitable buffer.

The invention also provides a kit for use in a haptoglobin assay according to the present invention comprising haemoglobin, reagents for generating hydrogen peroxide, one or more chromogens which undergo an optically detectable change when peroxidase activity is present and a buffer.

By means of the invention, an assay method for determining the level of haptoglobin in a sample is provided which exploits the endogenous activity of haptoglobin to bind to haemoglobin by determining the peroxidase activity of haemoglobin complexed to the haptoglobin but which avoids the need to include hydrogen peroxide as a reagent in order to provide a substrate for this peroxidase activity. The development of a peroxide free assay for haptoglobin in which the hydrogen peroxide substrate is generated in situ is particularly advantageous as it avoids the practical limitations placed on the assay when unstable and highly active hydrogen peroxide is used directly as a reagent, thereby facilitating the use of the assay in a wide range of situations and assay formats.

### DETAILED DESCRIPTION OF THE INVENTION

The assay method according to the present invention may suitably be performed on a blood sample, such as plasma or serum, from any animal. Alternatively, the sample for use in the assay may comprise other biological fluids such as peritoneal fluid, synovial fluid, cerebrospinal fluid milk. In one embodiment, the sample may be obtained from a mammal including a human.

In one embodiment, the haptoglobin concentration in the sample is in the range of from 0.02 mg/ml to 1.4 mg/ml.

The haemoglobin for use in the assay method according to the invention may be obtained from the same animal from which the sample for assay is obtained or it may be obtained from a different species.

In one embodiment, the haemoglobin is met-haemoglobin.

In the assay method according to the invention, the haptoglobin in the sample and the added haemoglobin react together to form a haptoglobin-haemoglobin complex.

In one embodiment, the assay reaction mixture is incubated for up to 20 minutes, for example from 5 to 20 minutes.

Formation of the haptoglobin-haemoglobin complex according to the method of the invention is detected by determining the peroxidase activity of the complex by measuring the change in an optical property of the reaction mixture. The level of peroxidase activity of the haptoglobin-haemoglobin complex can then be correlated with the amount of haptoglobin in the sample.

In the assay method according to the invention, the peroxidase activity of the haptoglobin-haemoglobin complex is determined by generating hydrogen peroxide in situ in the assay to form a substrate for the peroxidase activity of the complex and detecting the peroxidase activity using a chromogen which undergoes a spectroscopically detectable change when peroxidase activity is present.

The reagents for generating hydrogen peroxide for use according to the present invention suitably comprise an enzyme that catalyses a reaction which produces hydrogen peroxide as a reaction product together with a substrate for that enzyme.

In one embodiment of the present invention, the reagents for generating hydrogen peroxide comprise the enzyme glucose oxidase and the substrate glucose.

It will be appreciated that other suitable enzyme/substrate combinations may be used to generate hydrogen peroxide in situ in the assay. Any hydrogen peroxide generating enzyme/substrate combination conventional in the art may be used such as cholesterol/cholesterol oxidase or urea/urea oxidase.

Chromogens which undergo a spectroscopically detectable change when peroxidase activity is present are well known in the art and are described, for example, in EP 1031035B1 discussed above.

Any chromogenic substrate known in the art for assaying haemoglobin levels may conveniently be used in the assay according to the present invention. In one embodiment, the peroxidase activity of the haemoglobin-haptoglobin complex of the assay according to the invention is determined using a chromogen which undergoes a colour change which may be detected spectrophotometrically when peroxidase activity is present such as phenol, 4-iodophenol, 3-aminophenozone, 8-anilinonaphthalene sulphonic acid (ANS), 4-aminoantipyrine (AAP), 2-amino-4-hydroxybenzenesulphonic acid (AHBS), tetramethyl benzidine (TMB), O-phenylene diamine dihydrochloride, O-dianisidine, sodium-2-hydroxy-3,5-dichlorobenzene sulphonate, 2,2′-azino-di(3-ethylbenzthiazoline-6-sulphonic acid (ABTS) or mixtures thereof.

In one embodiment, the chromogenic substrate for use in the assay according to the present invention comprises a combination of phenol, 8-anilinonaphthalene sulphonic acid (ANS) and 4-aminoantipyrine.

Detectable colour changes can be detected with chromogens present in a variety of concentration ranges conventional in the art.

Both the peroxidase activity of the haptoglobin-haemoglobin complex and the activity of the reagents generating the hydrogen peroxide in situ are pH dependent and the challenge addressed by the present invention is therefore to find a pH range in which both activities are operative.

It is known from the art that peroxidase activity of uncomplexed haemoglobin can be inactivated at low pH. As reported in Jpn. J Vet. Sci, 44, p15-21 (1982), this activity can be inactivated at pH 4.1. It has been suggested, however, that peroxidase activity resulting from free haemoglobin may remain at such a pH and the assay described in EP 1031035B1 discussed above is preferably carried out at a pH below 4.1, especially at pH 3.8.

The present inventors have however found that by performing the assay method of the present invention in the presence of a buffer at a pH in the range of from 3.9 to 4.5, the peroxidase activity of any uncomplexed haemoglobin remaining in the assay mixture can be substantially suppressed without inhibiting in situ hydrogen peroxide generation.

In one embodiment, the assay method according to the present invention is performed in the presence of a buffer at a pH in the range of from 4 to 4.5.

In a particular embodiment, the assay method of the invention is performed at a pH of 4.1.

Any buffer conventional in the art may be employed to maintain the desired pH for the assay. Conveniently, a mixed citrate-phosphate buffer may be employed with the phosphate buffer (pH 7.4) being titrated to the desired pH with citrate buffer (pH 3.8).

It is known from EP 1031035B1 that albumin and other proteins present in blood samples have an undesirable “peroxidase effect” on haptoglobin assays which rely on the innate peroxidase activity of a haptoglobin-haemoglobin complex,

In one embodiment, therefore, the assay method of the invention is performed in the presence of one or more additional reagents for reducing the peroxidase effect due to any albumin or other proteins in the sample. It will be appreciated that such additional reagent or reagents will be added in an amount which is insufficient to substantially inhibit formation of the haptoglobin-haemoglobin complex.

Suitable additional reagents for reducing the peroxidase effect due to any albumin or other proteins in the sample are as described in EP 1031035B1 and include for example, protein binding inhibitors, reducing agents effective against disulphide bonds and chaotropic agents.

In one embodiment, the additional reagent or reagents may be present in a concentration of from 0.1 to 0.5 mM.

In one embodiment, the assay method according to the present invention is performed in the presence of a protein binding inhibitor such as 8-anilinonaphthalene sulphonic acid (ANS), protoporhyrin, bilirubin, taurodeoxycholic acids (bile salts), dicoumarol or 2-mercaptobenzothiazole.

In another embodiment, the additional reducing agent effective against disulphide bonds is selected from dithiothreitol, dithioerythritol, cysteine, mercaptoethanol, glutathione, 4,4′-dithiopyridine or 5,5′-dithio(2-nitrobenzoic acid).

In another embodiment, the assay method according to the present invention is performed in the presence of a suitable chaotropic agent such as guanidine hydrochloride, potassium thiocyanate or sodium chloride.

The assay according to the invention suitably further comprises a detergent to help maintain the other components in solution.

In one embodiment, a detergent is added to the assay mixture in a low concentration, suitably in an amount of up to 0.3%(v/v)

Suitable detergents which may be employed include non-ionic and ionic surfactants conventional in the art.

In one embodiment, the detergent for addition to the assay mixture comprises a non-ionic surfactant such as a polyoxylene sorbitol ester (for example Tween™ 20, 40, 60, 80), a polyoxyethylene alcohol (for example Brij™ 35,36) or a mixture thereof.

In another embodiment, the detergent comprises one or more ionic surfactants such as sodium dodecyl sulphate or cetrimide.

It will be appreciated that the assay reagents may be added together in any sequence provided that the spectroscopically detectable change in the chromogen does not occur prior to initiation of the assay. For example, the reagents may be pre-mixed in various stable combinations and brought together with the sample to perform the assay.

An antibacterial agent may be included with one or more of the reagents or reagent mixtures to act as a preservative. Suitable ingredients include, for example, triclosan or thiomersalate.

In one embodiment, first and second reagent mixtures are provided and the assay is performed by forming a mixture of the sample to be assayed and the first and second reagent mixtures.

In one embodiment, the first reagent mixture comprises haemoglobin and an enzyme that catalyses a reaction which produces hydrogen peroxide as a reaction product and the second reagent mixture comprises one or more chromogens and a substrate for the enzyme of the first mixture. Suitably the enzyme comprises glucose oxidase and the enzyme substrate comprises glucose.

In another embodiment, one or more of the chromogens is included in the first reagent mixture together with the haemoglobin and an enzyme that catalyses a reaction which produces hydrogen peroxide as a reaction product.

In one embodiment, some or all of the component assay reagents can be combined in dry form and then added to the aqueous sample in order to perform the assay.

Suitably, assay reagent combinations may be prepared in solution and freeze-dried onto a solid surface such as paper or an assay stick.

A dry format such as this is particularly convenient for storage and portability and this represents a significant advantage for the method of the invention compared to prior art methods as this cannot be achieved where hydrogen peroxide is required as one of the reagents.

The level of peroxidase activity determined for the haptoglobin-haemoglobin complex formed in the assay method according to the invention can be correlated with the level of haptoglobin in the sample by reference to a standard curve generated using known concentrations of haptoglobin.

The kit for use in the method according to the invention may suitably comprise further components such as standards of serum with known haptoglobin concentrations.

In one embodiment, the assay method according to the invention may suitably be performed using equipment such as test tubes or microtitre plates. Alternatively, the assay may be performed using an automated biochemical analyser.

Throughout the description and claims of this specification, the words “comprise” and “contain” and variations of the words, for example “comprising” and “comprises”, mean “including but not limited to”, and do not exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Preferred features of each aspect of the invention may be as described in connection with any of the other aspects. Other features of the present invention will become apparent from the following examples.

Generally speaking the invention extends to any novel one, or any novel combination, of the features disclosed in this specification (including any accompanying claims and drawings). Thus features, integers, characteristics, compounds, chemical moieties or groups described in conjunction with a particular aspect, embodiment or example of the invention are to be understood to be applicable to any other aspect, embodiment or example described herein unless incompatible therewith.

Moreover unless stated otherwise, any feature disclosed herein may be replaced by an alternative feature serving the same or a similar purpose.

The present invention will now be further illustrated by way of reference to the following non-limiting examples.

### EXAMPLES

The following solutions and general procedures were used—

Stock Solutions:

Reagent A: Haemoglobin and glucose oxidase

Phosphate buffer 0.05M pH 7.4

Equine haemoglobin at 30 mg/ml prepared according to Makimura & Susuki, (1982. Jap J Vet Sci 44:15-21) in ultrapure water Glucose oxidase (Sigma) 10 mg/ml in phosphate buffer

Reagent B: chromogen/glucose

Stocks Solutions:

Citrate buffer 0.5 M, pH 3.8

Phosphate buffer 0.05 M, pH 7.4

Sodium chloride 0.15 M, 1% (v/v) tween 20 (saline/tween) 4-aminoantipyrine (AAP) 158 mM in saline/tween 8-anilino-1-naphthaline sulphonic acid (ANS) 33 mM in saline/tween

Phenol 1.1M in saline/tween

Dithiothreitol (DTT) 65 mM in saline/tween

Cysteine (Cys) 129.65 mM in saline/tween

Glucose (Glu) 0.5M in phosphate buffer

Samples

Water as blank

Foetal calf serum (FCS), as a negative control serum (Sigma)

Bovine serum albumin 2% (w/v) (BSA) as anegative control (Sigma)

Bovine serum with haptoglobin at 1.4 mg/ml

Bovine and canine serum samples.

Procedures

During development, for proof of principle and for optimisation of assay reagents the procedure was carried out in the wells of microtitre plates at room temperature with absorbances being read in an ELISA plate reader (Ultrastar, BMGLabtech) at 600 nm after 10 or 20 min. Thereafter development was performed on an automated biochemical analyser (MIRA, Roche) or a Prestige analyser (Triodiagnostic Ltd) at 37° C.

### Example 1

### On Microtitre Plate

Reagent A

A 50 μl aliquot of equine haemoglobin stock solution was added to 25 ml of phosphate buffer. 1.25 ml of glucose oxidase stock solution was added to 10 ml of the diluted haemoglobin solution.

Reagent Bi To 1.0 ml of citrate buffer pH3.8 with 1% Tween 20, 0.01 ml AAP; 0.02 ml phenol; 0.03 ml ANS; 0.006 ml DTT were add

Reagent Bii

To 1.0 ml of phosphate buffer pH7.4. 0.01 ml of AAP; 0.02 ml of phenol; 0.03 ml of ANS; 0.006 ml of DTT were added

Working reagent B

1 ml of reagent Bi was mixed with 1 ml of reagent Bii and 0.56 ml of 0.5M glucose in phosphate buffer was added.

Samples (6 μl) were placed in wells followed by 100 μl of haemoglobin/glucose oxidase reagent A and 100 μl of chromogen reagent B, incubated 10 min at room temperature and the absorbance was measured on ELISA reader at 595 nm

The results obtained are presented in Table 1 below

TABLE 1

| Sample | A 595 nm |
|---|---|
| Bovine serum (Hp = 1.4 mg/ml) | 2.61 |
| BSA 2% (w/v) | 0.16 |
| Water | 0.17 |

Haptoglobin in serum produced a dark blue colour in the reaction while FCS and water gave minimal reaction.

### Example 2

### Comparison of DTT to Cys as Reducing Agent

DTT is known to be the most unstable of the reagent mix and an alternative reagent capable of reducing SS double bonds would enhance stability of the haptoglobin assay.

In an experiment to compare the effectiveness of cysteine and DTT in inhibiting background peroxidise activity, samples (4 μl) were placed in wells followed by 75 μl of haemoglobin/glucose oxidase reagent A and 75 μl of chromogen Bi DTT or Bii Cys, incubated 30 min at room temperature and the absorbance was measured on ELISA reader at 600 nm

Working Solutions

Working Reagent A To 2.5 ml of phosphate buffer, 5 μl of haemoglobin and 30 μl of glucose oxidase solutions were added.

Working Reagent Bi DTT

10 ml citrate buffer+10 ml phosphate buffer (pH 4.1)

Then add per 1 ml of mixed buffer:

0.01 ml AAP

0.03 ml ANS

0.02 ml phenol

0.006 ml DTT

0.25 ml Glu

Working Reagent Bii Cys

10 ml citrate buffer+10 ml phosphate buffer (pH 4.1)

Then add per 1 ml of mixed buffer:

0.01 ml AAP

0.03 ml ANS

0.02 ml phenol

0.012 ml Cys

0.25 ml Glu

The results obtained are presented in Table 2 below.

TABLE 2

A 600 nm

| | B1 DTT | B2 Cys |
|---|---|---|
| Bovine serum (Hp = 1.4 mg/ml) | 1.86 | 1.71 |
| FCS | 0.19 | 0.20 |
| Water | 0.16 | 0.17 |

The results show that using cysteine as the reducing agent to inhibits the background peroxidase activity is as effective as DTT.

### Example 3

### pH Optimisation

(a) pH 3.9-4.5

The effect of changing the pH on the haptoglobin reaction was determined on microtitre plate assay. Buffers for reagent B were prepared by mixing citrate buffer and phosphate buffer as below (Table 3) and adding other chemicals as for Bi DTT in Example 2 with DTT as the reducing agent.

The pH of the buffer mixes (B2-B5) was determined after addition of all chemicals. Samples (5 μl)were placed in wells followed by 90 μl of haemoglobin/glucose oxidase reagent A and 90 μl of chromogen B3-B6, incubated 20 min at room temperature and the absorbance was measured on ELISA reader at 600 nm

TABLE 3
pH of reaction buffers

| | Volume | Volume | |
|---|---|---|---|
| | Citrate | Phosphate | Measured |
| Reagent | buffer ml | buffer ml | pH |
| B2 | 10 | 0 | 3.95 |
| B3 | 7.5 | 2.5 | 4.01 |
| B4 | 5 | 5 | 4.10 |
| B5 | 2.5 | 7.5 | 4.44 |

The results obtained are shown in Table 4 below.

TABLE 4
Absorbance at 20 min (A 600 nm)

| | B2 pH | B3 pH | B4 pH | B5 pH |
|---|---|---|---|---|
| | 3.95 | 4.01 | 4.10 | 4.44 |
| Bovine serum | 0.61 | 0.59 | 1.06 | 1.48 |
| (Hp = 1.4 mg/ml) | | | | |
| FCS | 0.19 | 0.83 | 0.63 | 0.16 |
| Water | 0.16 | 0.17 | 0.55 | 0.15 |

From the results it can be seen that at pH of 4.1 and 4.4 the haptoglobin has the highest reaction and at pH 4.44 the minimal reactions in the blank and negative serum samples.

(b) pH 4.1-6.0

Buffers (B6-B10) of differing pH as listed in Table 5 were prepared by titrating phosphate buffer pH 7.4 with citrate buffer pH 3.8 and adding reagents as under Example 2 Reagent Bi DTT. Samples (4 μl ) were placed in wells followed by 75 μl of haemoglobin/glucose oxidase reagent A and 75 μl of chromogen B2-B5, incubated 30 min at room temperature and absorbance measured on ELISA reader at 600 nm

TABLE 5
pH of reaction buffers

| | B7 pH | B8 pH | B9 pH | B10 pH | B11 pH |
|---|---|---|---|---|---|
| | 4.14 | 4.5 | 4.99 | 5.48 | 5.98 |
| | B7 pH | B8 pH | B9 pH | B10 pH | B11 pH |
| | 4.14 | 4.5 | 4.99 | 5.48 | 5.98 |
| Bovine serum | 1.13 | .53 | .20 | .20 | .18 |
| (Hp = 1.4 mg/ml) | | | | | |
| FCS | .29 | .24 | .22 | .21 | .19 |
| Water | .19 | .23 | .19 | .19 | .18 |

It was found that above pH 4.5 the reaction does not proceed. At pH4.14 and 4.5 there is reaction and in this set of reagents the reaction at pH 4.14 was superior.

### Example 4

### Automated Analysis

The reagents optimised on microtitre plate were used on the automated biochemistry analyser (MIRA, Roche) according to the following method:

Reagent A

To 9 ml of phosphate buffer (0.05M, pH 4.51), 18 μl of haemoglobin and 108 μl of glucose oxidase solutions were added.

Reagent B

15 ml of 0.05M phosphate buffer pH 7.4 was titrated to pH 4.14 with 0.5M citrate buffer pH 3.8 (˜5.3 ml)

The following reagents were added per 1 ml of mixed buffer:

0.01 ml AAP

0.03 ml ANS

0.02 ml phenol

0.006 ml Cys

0.25 ml Glu

On the MIRA analyser Reagent A was placed as the 1st reagent and Reagent B12 as the 2nd reagent to be added. Assay parameters were set so that

Sample volume=0.0052 ml

1st Reagent (A)=0.09 ml

2nd Reagent (B12)=0.09 ml

Additions should be 1st reagent, add sample, add reagent B12 and read at cycle 1-15 (25 sec apart) at 600 nm. The change in absorbance at 600 nm between cycle 2 and cycle 15 (350 sec) is the reading (ΔA₆₀₀)

Samples:

Standard curve of Hp in serum at 1.4, 0.7, 0.35 and 0 g/L

Controls of saline, FCS, 4% (w/v) bovine serum albumin (BSA)

Samples: serum with elevated Hp concentrations.

The results obtained are presented in Table 6.

TABLE 6
Automated analysis

| | ΔA₆₀₀ | Hp g/l* |
|---|---|---|
| Standard 1.4 g/l | 0.7488 | |
| Standard 0.7 g/l | 0.3411 | |
| Standard 0.34 g/l | 0.1451 | |
| **Standard 0.0 g/l | 0.0039 | |
| Saline | 0.0039 | 0 |
| 4% BSA | 0.0048 | 0.02 |
| FCS | 0.0050 | 0.02 |
| Sample 1, canine | 0.4394 | 0.92 |
| Sample 2, feline | 0.3889 | 0.83 |
| Sample 3, bovine | 0.6272 | 1.25 |
| Sample 4, porcine | 0.7029 | 1.39 |

*calculated from standards by analyser
**ultrapure water

The reagents using glucose oxidase and glucose to generate the peroxide for the assay system gives a linear curve with haptoglobin standards and automated result output. The low level of apparent haptoglobin observed with 4% albumin and FCS s residual background activity and in analysis can be overcome by using either of these (4% BSA or FCS) as the zero standard as in current assay method.

### Example 5

### Dry Chemistry Test for Haptoglobin

Without the need for peroxide to be provided for the reaction, the reagents are usable in a dry chemistry format. In order to minimise the interaction of the reagents before dry they were added in order and after the final reagent were immediately frozen prior to drying under a vacuum (lyophilisation).

Reagent A as in Example 1

Reagent B as in Example 1

Reagent A (0.025 ml) was dispensed as spots on to filter paper (Biorad) and allowed to air dry and placed in a plastic bag on dry ice for 60 min. Ice cold Reagent B (0.025 ml) was dispensed as spots on top of the previously dispensed Reagent A, replaced in the plastic bag on dry ice for 30 min. The filter paper was placed in a freeze drier overnight.

Bovine serum (0.01 ml) with haptoglobin at 0.74 and 0.35 g/l (1:2 and 1:4 dilution of the 1.4 g/l standard used in example 4) and BSA at 5 g/l and 2.5 g/l placed on the dried spots and incubated for about 5 min with colour development recorded by scanning.

The new reagents when dried onto filter paper gave a deep blue/purple reaction with 5 min of application of a sample containing Haptoglobin but a negative reaction with BSA.

### Example 6

### Optimised Wet Chemistry Assay Bovine Samples

Further optimisation studies were performed involving adjustment to reagent concentrations and with aminoantipyrine in Reagent A. A Prestige (Triodiagnostic Ltd) biochemical analyser was used to determine haptoglobin in bovine serum samples.

Reagent A: Haemoglobin/Glucose Oxidase/Aminoantipyrine

Dissolved in deionised water:

| Sodium chloride (Sigma) | 0.154M | |
|---|---|---|
| Glucose oxidase (Sigma) | 0.6 mg/ml (105 U/ml) | |
| Equine haemoglobin | 0.26 | mg/ml |
| 4-aminoantipyrine (Sigma) | 3.1 | mM |
| Triclosan (Fluka) | 0.0001% | (v/v) |

Reagent B

Dissolved in deionised water and with pH at 4.1

| Citric acid (Sigma) | 0.06M | |
|---|---|---|
| Disodium hydrogen phosphate (Fluka) | 0.08M | |
| Glucose (Sigma) | 0.5M | |
| Tween 20 (Sigma) | 1% | (v/v) |
| Phenol (Sigma) | 0.02M | |
| 8-Anilino-1-naphthalenesulfonic acid (Fluka) | 1.5 | mM |
| L-cysteine. (Sigma) | 0.82 | mM |
| Triclosan (Fluka) | 0.0001% | (v/v) |

Prestige Analyser Protocol:

Sample: 4 μl

Water diluent: 10 μl

Reagent 1=A2: 200 μl

Reagent 2=B13: 90 μl

Blank: normal bovine serum

Calibrators: haptoglobin at 1.48 g/L, 0.74 g/L, 0.37 g/L, 0.19 g/L, 0.048 g/L in normal bovine serum Calculation mode: Logit 2

The results obtained are shown in Table 7

TABLE 7

| | ΔA₆₀₀ | Hp g/l* |
|---|---|---|
| Standard 1.48 g/L | 0.1759 | |
| Standard 0.74 g/L | 0.3069 | |
| Standard 0.37 g/L | 0.4843 | |
| Standard 0.19 g/L | 0.8635 | |
| Standard 0.048 g/L | 1.9117 | |
| Blank (NBS) 0.0 g/l | 0.1303 | |
| Foetal calf serum | | 0.00 |
| Sample 1 | | 0.00 |
| Sample 2 | | 0.02 |
| Sample 3 | | 0.42 |
| Sample 4 | | 0.57 |
| Sample 5 | | 0.49 |

*Hp concentration calculated by on-board computer based on □A₆₀₀ of the standards.
Samples 1-5 are from a calf during an acute phase reaction.

### Example 7

### Optimised Wet Chemistry Assay Canine Samples

Reagents as in Example 6 used on a Pentra 400 (Horiba Abx Ltd) analyser to determine haptoglobin in canine serum samples. Samples were diluted 1:10 prior to analysis in 0.9% (w/v) NaCl and analysed in duplicate. Results given are after calculation to adjust for the dilution and are the mean of the duplicates.

Pentra Analyser Protocol:

Sample: 7.5 μl

Water diluent: 5 μl

Reagent 1=A2: 150 μl

Reagent 2=B13: 60 μl

Blank and Calibrator Diluent: 2% (w/v) bovine serum albumin (BSA)

| Sodium chloride (Sigma) | 0.154M | |
|---|---|---|
| BSA Frac V (Sigma) | 20.0 | g/L |
| Triclosan (Fluka) | 0.0001% | (v/v) |

Calibrators: haptoglobin at 1.48 g/L, 0.74 g/L, 0.37 g/L, 0.19 g/L diluted in calibrator diluent,

Calculation mode: Logit/Log4

The results obtained are shown in Table 8

TABLE 8

| | ΔA₆₀₀ | Hp g/l* |
|---|---|---|
| Standard 1.48 g/L | 3.0938 | |
| Standard 0.74 g/L | 1.9997 | |
| Standard 0.37 g/L | 1.0009 | |
| Standard 0.19 g/L | 0.5719 | |
| Blank (2% BSA) 0.0 g/l | 0.1029 | |
| Sample 6 | | 0.05 |
| Sample 7 | | 0.75 |
| Sample 8 | | 4.7 |
| Sample 9 | | 6.65 |

*Hp concentration calculated by on-board computer based on ΔA₆₀₀ of the standards
Samples 6-7 are from dogs with haptoglobin in the range found in healthy dogs and samples 8-9 are from dogs with inflammatory or infectious conditions.

1. A method for determining a level of haptoglobin in a sample said method comprising:
mixing haemoglobin with the sample to be assayed so as to form a haptoglobin-haemoglobin complex with haptoglobin present in the sample;
(ii) contacting the product of step (i) with reagents for generating hydrogen peroxide and one or more chromogens which undergo an optically detectable change when peroxidase activity is present, in the presence of a buffer, under conditions in which hydrogen peroxide is generated from said reagents and forms a substrate for the peroxidise activity of the haptoglobin-haemoglobin complex present, and wherein the pH of the buffer is within a range which is sufficiently low that the peroxidise activity of any uncomplexed haemoglobin is substantially suppressed but sufficiently high that hydrogen peroxide generation occurs;
(iii) determining the peroxidase activity of the haptoglobin-haemoglobin complex by measuring the change in an optical property of the reaction mixture; and
(iv) determining the level of haptoglobin in said sample from the level of peroxidise activity of the haptoglobin-haemoglobin complex.

2. The method according to claim 1, wherein steps (i) and (ii) are carried out concurrently.

3. The method according to claim 1, wherein the assay is carried out at a pH in the range of from pH 3.9 to pH 4.5.

4. The method according to claim 3, wherein the assay is carried out at a pH in the range of from pH 4 to pH 4.5.

5. The method according to claim 4, wherein the assay is carried out at a pH of 4.1.

6. The method according to claim 1, wherein the reagents for generating hydrogen peroxide comprise an enzyme that catalyses a reaction which produces hydrogen peroxide as a reaction product together with a substrate for said enzyme.

7. The method according to claim 6, wherein the reagents for generating hydrogen peroxide comprise the enzyme glucose oxidase and the substrate glucose.

8. The method according to claim 1, wherein the chromogen undergoes a colour change when peroxidise activity is present which may be detected spectroscopically.

9. The method according to claim 8, wherein the chromogen is selected from the group consisting of phenol, 4-iodophenol, 3-aminophenozone, 8-anilinonaphthalene sulphonic acid (ANS), 4-aminoantipyrine (AAP), 2-amino-4-hydroxybenzenesulphonic acid (AHBS), tetramethyl benzidine (TMB), O-phenylene diamine dihydrochloride, O-dianisidine, sodium-2-hydroxy-3,5-dichlorobenzene sulphonate and 2,2′-azino-di(3-ethylbenzthiazoline-6-sulphonic acid (ABTS), and mixtures thereof.

10. The method according to claim 9, wherein the chromogen comprises a combination of phenol, 8-anilinonaphthalene sulphonic acid (ANS) and 4-aminoantipyrine.

11. The method according to claim 1, wherein the assay is performed in the presence of one or more additional reagents for reducing the peroxidase effect due to albumin or other proteins in the sample.

12. The method according to claim 11, wherein the one or more additional reagents are selected from the group consisting of a protein binding inhibitor, a reducing agent effective against disulphide bonds, a chaotropic agent, and mixtures thereof.

13. The method according to claim 12, wherein the protein binding inhibitor comprises a protein binding inhibitor selected from the group consisting of 8-anilinonaphthalene sulphonic acid (ANS), protoporhyrin, bilirubin, taurodeoxycholic acids (bile salts),dicoumarol, and 2-mercaptobenzothiazole.

14. The method according to claim 12, wherein the reducing agent comprises an agent selected from the group consisting of dithiothreitol, dithioerythritol, cysteine, mercaptoethanol, glutathione, 4,4′-dithiopyridine, and 5,5′-dithio(2-nitrobenzoic acid).

15. The method according to claim 12, wherein the chaotropic agent comprises a chaotropic agent selected from the group consisting of guanidine hydrochloride, potassium thiocyanate, and sodium chloride.

16. The method according to claim 1, wherein the assay mixture further comprises a detergent.

17. An assay The method according to claim 1, wherein the assay mixture further comprises an antibacterial agent.

18. An assay The method according to claim 1, wherein the assay is performed by forming a mixture of the sample to be assayed and first and second reaction mixtures.

19. The method according to claim 18, wherein the first reagent mixture comprises haemoglobin and an enzyme that catalyses a reaction which produces hydrogen peroxide as a reaction product and the second reagent mixture comprises one or more chromogens and a substrate for the enzyme of the first mixture.

20. The method according to claim 19, wherein the one or more chromogens is included in the first reaction mixture.

21. The method according to claim 1, wherein some or all of the component assay reagents are combined in dry form and then added to the an aqueous sample in order to perform the assay.

22. The method according to claim 21, wherein the assay reagent combinations are prepared in solution and freeze-dried onto a solid surface.

23. The method according to claim 22, wherein the solid surface is paper or an assay stick.

24. The method according to claim 1, wherein the amount of haptoglobin in the sample is determined from the level of peroxidase activity of the haptoglobin-haemoglobin complex by reference to a standard curve generated using known concentrations of haptoglobin.

25. A kit for use in a haptoglobin assay according to claim 1, comprising haemoglobin, reagents for generating hydrogen peroxide, one or more chromogens which undergo an optically detectable change when peroxidase activity is present and a buffer.

26-27. (canceled)
